(19) United States
(12) Patent Application Publication
(10) Pub. No.: US 2004/0265526 A1
(43) Pub. Date: Dec. 30, 2004

(54) Spiral wound tubes, method and apparatus for forming the same

(75) Inventor: Daniel Christy Jones, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/610,044

(22) Filed: Jun. 30, 2003

(51) Int. Cl. B32B 1/08

(52) U.S. Cl. 428/36.9

(57) ABSTRACT

Spiral wound tubes may be formed utilizing the method and apparatuses described herein. The method includes providing a mandrel and a web material having a first overlap region and a second overlap region. A binding agent is applied to at least one of the overlap regions. The mandrel is wrapped with the web material such that the second overlap region covers the first overlap region of the previously wound web and the binding agent is disposed between the previously wound first overlap region and the currently wound second overlap region. The spiral wound tubes of the invention demonstrate improved axial crush resistance.

### FIELD OF THE INVENTION

This invention relates to spiral wound tubes. More particularly, this invention relates to single ply, spiral wound tubes, and to methods and apparatuses for winding the tubes.

### BACKGROUND OF THE INVENTION

Spiral wound tubes are well known. Web materials such as aluminum foil, tissue paper, hard grades of paper and the like are provided to consumers wound on spiral wrapped paper tubes.

Typical spiral wound tubes are comprised of at least two plies of paper web. The outer ply completely overlaps the inner ply and a layer of binding agent is disposed between the outer and inner plies. These tubes comprise fully overlapped plies and therefore the outer circumferential surface of the tubes is generally smooth.

A tube comprising a single ply of web material requires less web material and less bonding agent to form the tube. Less equipment is necessary since only a single roll of web material is provided at a time. Less time is spent changing rolls of web material for the same reason.

### SUMMARY OF THE INVENTION

Spiral wound tubes comprising a single ply of paper web material may be formed by the method and apparatus herein described. In one embodiment, the method comprises steps of providing a mandrel and a single ply of web material. The web material comprises an outer surface, having a first region, and an inner surface, opposed to the outer surface and having a second region. A binding agent is applied to at least one of the first region and the second region. The web material is wound about the mandrel. The first region of the previously wound web is covered by the second region of the currently wound web. The binding agent is disposed between the first region of the previously wound web and the second region of the currently wound web and binds the successive wraps of the web one to the next.

In one embodiment the apparatus comprises a mandrel, a binding agent applicator, and a binding agent reservoir coupled to the applicator. In another embodiment, the apparatus further comprises a binding agent pump and a binding agent conduit coupling the output of the pump and the applicator.

### BRIEF DESCRIPTION OF THE DRAWINGS

FIG. 1a is a schematic side view of the apparatus according to one embodiment of the invention.

FIG. 1b is a schematic side view of the opposite side of the embodiment of the invention illustrated in FIG. 1a.

FIG. 2 is a lateral cross sectional view of a spiral wound tube made according to the method of the invention.

FIG. 3 is a schematic side view of a second embodiment of the apparatus of the invention.

All test methods and patents cited in the Detailed Description of the Invention, are hereby incorporated herein by reference.

### DETAILED DESCRIPTION OF THE INVENTION

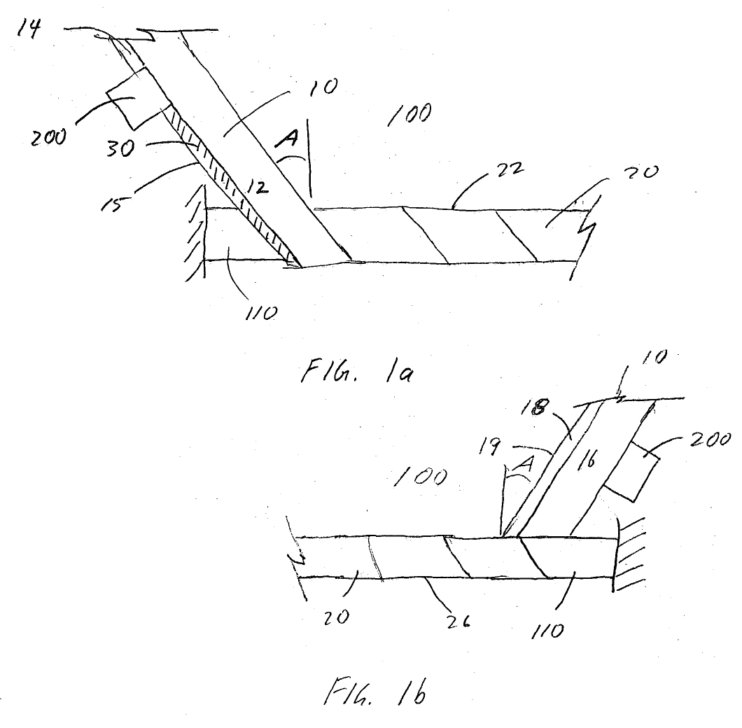

As illustrated in FIG. 1a and FIG. 1b, web material 10 is provided to a winding apparatus 100 at an angle A. The web material 10 is provided from a parent roll and the length of the web material 10 is substantially greater than the width or thickness of the material. The thickness of the web material across its width may be uniform or may vary due to the method used to manufacture the web material 10. The web material 10 has a first surface 12 that forms the outer surface 22 of the wound tube 20. The first surface 12 has a first overlap region 14 adjacent to a first lateral edge 15 of the web material 10. The web material 10 has a second surface 16 that forms the inner surface 26 of the wound tube 20. The second surface 16 has a second overlap region 18 adjacent to a second lateral edge 19 of the web material 10.

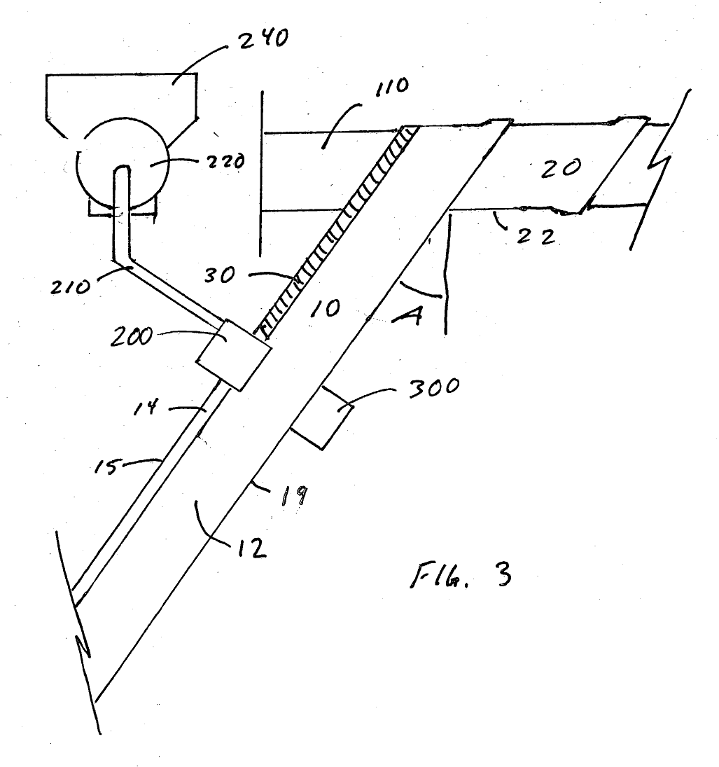

According to FIG. 1a the web material 10 is routed proximally to an applicator 200. A binding agent 30 is applied to the web material 10 from the applicator 200. In the embodiment illustrated in FIG. 1a, the binding agent 30 is applied to the first overlap region 14 of the web material 10. In another embodiment, the binding agent 30 may be applied to the second overlap region 18 of the web material 10. In yet another embodiment, illustrated in FIG. 3 the binding agent 30 may be applied to both to the first overlap region 14 by a first applicator 200 and to the second overlap region 18 by a second applicator 300. In this embodiment, a single-component binding agent may be applied to both the second overlap region 18 and the first overlap region 14. Alternatively, a first component of a two part binding agent system may be applied to the first overlap region 14 by a first applicator 200 and a second component of a two component binding agent system may be applied to the first overlap region by a second applicator 300. The binding agent may comprise a single-component adhesive, a multi-component adhesive, a single-component cohesive, or a multi-component cohesive. An exemplary binding agent is Resyn™ 32-1357, available from National Starch and Chemical, Bridgewater, N.J.

The applicator 200 may comprise a slot extruder. The slot extruder comprises a pair of opposed plates separated a predetermined distance by a shim or set of shims. A gap is cut in the shim or shim set such that a slot as wide as the gap and as long as the thickness of the shim(s) is present between the opposed plates. The binding agent 30 is disposed onto the web material 10 from the slot. The web material 10 may be routed to contact the slot extruder such that the deposited film of binding agent is maintained at a desired film thickness and such that a generally uniform thickness binding agent layer is deposited on the web 10.

As shown in FIG. 3, a binding agent conduit 210 may connect the slot extruder to the output of a binding-agent pump 220. The input of the binding-agent pump 220 is disposed to receive binding agent from a binding-agent reservoir 240. In another embodiment, the slot extruder may be incorporated into a lower portion of a binding agent reservoir. The binding agent then proceeds from the slot extruder under the influence of gravity.

The applicator 200, applies a thin film of binding agent to the web material 10. The width of the film may correspond to the width of the overlap region to which the binding agent is applied. In another embodiment, the width of the film of binding agent 30 may be less than the width of the overlap region to allow for some spreading of the film of binding agent 30 after application and prior to the final set of the binding agent 30. In another embodiment, the width of the film may be wider than the width of the overlap region. The additional binding agent 30 is disposed along the seam on the outer surface of the tube 20. The presence of the additional binding agent 30 may reduce the possibility that the tube 20 will delaminate at the seam if the tube 20 is cut into discrete lengths. The width of the film of the binding agent 30 may have a width that is about 0.03 to about 0.125 inches (about 0.76 to about 3.17 mm) wider than the overlap region. If the width of the film is excessively wider than the width of the overlap region, winding machine hygiene problems may be created.

As illustrated in FIG. 1a and FIG. 1b, the web material 10 is routed from the binding agent applicator 200 to the mandrel 110. The web material 10 is wound about the mandrel 110. The first overlap region of a previous winding may be covered by the second overlap region of the next successive winding. Previous winding and successive winding refer respectively to sequential 360° wraps of the mandrel 110 by the web material 10. A new wrap may begin after 360° of wrap as the web material 10 begins to overlap the previous wrap or winding.

The mandrel 110 may be stationary, or the mandrel 110 may be capable of rotating about the winding axis of the tube by supporting the mandrel 110 with rolling element bearings or bushing material. A rotating mandrel 110 may be freely turning or may be driven. The driven mandrel 110 may be driven directly by a motor integral to the mandrel or by being directly coupled to a motor. The mandrel may be indirectly driven through the use of belts, chains, or gears, as are known in the art. The driven mandrel 110 may be driven by a variable speed drive system. The speed of the mandrel 110 may be varied according to the speed of the web material 10 being wound about the mandrel 110. The surface of the driven mandrel may be a low friction or high friction surface. A high friction surface may comprise a knurled surface or a surface coated with a high friction material, or the mandrel may be comprised of a high friction material. A low friction surface may be used to reduce the build up of heat caused by the slipping of the web material 10 past the surface of the mandrel. A low friction surface may be achieved by the use of a low friction material in the fabrication of the mandrel 110 or by the coating of the mandrel 110 with a low friction material.

The winding of the web material 10 about the mandrel 110 may be accomplished by any means known in the art. In one embodiment, the web material 10 may be wound by imparting an appropriate torque to the web material 10 via the hand, or hands, of a human being. In an alternative embodiment, the torque may be imparted to the web material 10 by the use of a belt, or plurality of belts, as these methods are known in the art. The high friction mandrel described above, may be used in driving the motion of the web material 10 during the winding of the tube 20.

The web material 10 is wound about the mandrel 110 to produce a tube 20 having consistent dimensions. Wax may be applied to at least a portion of the inner surface of the web material 10 to reduce the friction between the web material and the mandrel during high speed winding operations. An exemplary wax is Cerelube™, available from Stevenson-Cooper, Inc., Philadelphia, Pa. The wax may be applied by contacting a block of wax with the moving web. An exemplary wax is In another embodiment, silicone may be applied to a portion of the inner surface of the web or to the mandrel. An exemplary silicone is Masil™ SF 500, available from PPG Industries, Pittsburg, Pa.

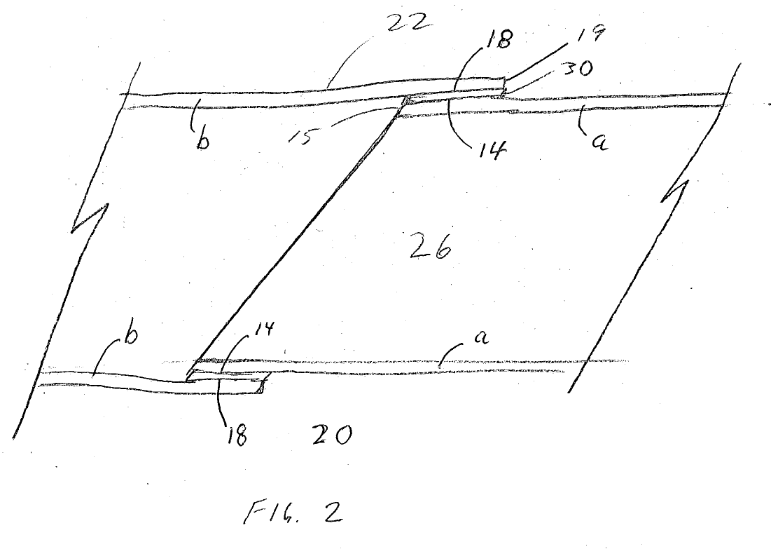

FIG. 2 illustrates the lateral cross section of a portion of a tube 20 made according to the present invention. FIG. 2 shows a previous winding a overlapped by a subsequent winding b. The binding agent 30 is disposed between the first overlap region 14 of previous winding a and the second overlap region 18 of subsequent winding b.

The wound core, or tube 20 may be cut to a desired length by using a mechanical core cutter (not shown) or a servo core cutter (not shown). Alternatively, the wound core 20 may be wound until the supply of web material 10 is depleted. Either the mechanical core cutter or the servo core cutter may traverse a path parallel to the mandrel while bringing a cutting blade into contact with the tube 20. The mechanical cutter comprises a knife type blade and the blade rotates freely about a center axis. The servo cutter comprises a drive motor to actively rotate the cutting blade against the tube 20. Both mechanical and servo cutter are known in the art.

An optional aspect of the method and apparatus of the invention comprises the treatment of the web material prior to winding the web material 10 about the mandrel 110 to increase the flexibility of the web material 10. The web material 10 may be moistened by a mist of water or by applying steam to the web material. Either the water mist or the steam may be applied to the web material 10 through the use of a spray nozzle adapted to handle the water or steam. The flexibility of the web material 10 may also be increased by the application of a softening agent to the web material 10.

Applicants have found that the axial crush strength of the single ply tubes of the present invention is greater than the axial crush strength of two ply tubes of similar diameter. Tubes comprising a single ply of 46 lb/1000 ft²(22.5 kg/100 m²) paperboard demonstrate more than a 20% increase in axial crush strength when compared to tubes comprising two plies of 26 lb/1000 ft² (12.7 kg/100 m²) paperboard. The tubes were tested using Composite Can and Tube Institute (CCTI) Axial End Crush test CT-107. An axial crush strength factor may be calculated by dividing the CT-107 test results by the basis weight of the tube paperboard in lbs/1000 ft². For the single ply tubes of the invention, the axial crush strength factor has an average value of 0.46. The axial crush strength factor for the tubes comprising two plies of 26 lb/1000 ² paperboard averaged 0.33.

The method of the invention is described by the following non-limiting example.

### EXAMPLE 1

A single ply of 46 pound/1000 ft² (22.5 kg/100 m²) kraft paper, 3-7/8 inches (9.842 cm) wide and approximately 17,500 feet (5334 m) long is delivered on a roll approximately 60 inches (1.524 m) in diameter. The roll is unwound and fed toward the core winding mandrel. A code is printed on the underside of the paper. The paper turns an encoder wheel and the speed of the paper is determined and transmitted to a Programmable Logic Controller (PLC). Wax is applied to the underside of the paper and National Starch and Chemical Resyn™ 32-1357 adhesive is applied to the first overlap region of the paper. The paper is captured between the inside surface of a driven belt and the outside surface of the mandrel and is wound about the mandrel. The paper is wound at an angle A such that the second overlap region of the paper overlaps the first overlap region of the previous wrap by about 0.375 inches (9.52 mm). The adhesive is therefore disposed between the first overlap region and the second overlap region of the paper.

The adhesive is applied utilizing an ITW Dynatec Ribbon-coater Nozzle, Model No. 106945 A2 V2, having a slot size of 0.375×0.015 inches (9.52×0.38 mm). This nozzle is mounted on an ITW Dynatec Mod Plus glue gun, Model No. BF0441BD2S. The adhesive is provided to the glue gun from a hot melt tank, ITW Dynatec Model No. S05, via glue hose ITW Dynatec Model No. 06×12, 20-24, HD/A, DC. The hot melt tank, the glue hose and the glue gun are each heated to a temperature of between 105° F. and 110° F. (40.5-43.3 C) Each of the above described components are available from ITW Dynatec of Hendersonville, Tenn., USA.

The tubes were produced on a Paper Converting Machine Company core winder, Model No. CM-12, available from the Paper Converting Machine Company of Green Bay, Wis., USA. The tubes were cut to a length of LENGTH utilizing a Paper Converting Machines core cutter model number ECM-14.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of wrapping a spiral tube, the method comprising steps of
a) providing a mandrel,
b) providing a web comprising a first overlap region, and a second overlap region,
c) applying a layer of binding agent to at least one overlap region,
d) wrapping the mandrel with the web wherein the binding agent is disposed between the second overlap region and the first overlap region.

2. The method of claim 1 wherein the step of applying a layer of binding agent to at least one overlap region further comprises extruding the binding agent onto the overlap region.

3. The method of claim 1 further comprising a step of heating the binding agent.

4. The method of claim 1 wherein the step of applying a layer of binding agent to at least one overlap region comprises applying a layer of binding agent to the second overlap region.

5. The method of claim 1 wherein the step of applying a layer of binding agent to at least one overlap region comprises applying a layer of binding agent to the first overlap region.

6. An apparatus for winding a single ply spiral wound tube, the apparatus comprising:
a) a mandrel capable of receiving a web to be wrapped,
b) a binding agent reservoir for providing a binding agent,
c) a slot extruder in fluid communication with the binding agent reservoir and capable of delivering the binding agent to the web associated with the mandrel.

7. A spiral wound tube comprising:
a) a single ply of web material, the web material comprising a second overlap region, and a first overlap region, wherein the web material is disposed around a circular cross section along a lateral axis, wherein the second overlap region overlaps the first overlap region
b) a thin film of a binding agent disposed between the second overlap region and the first overlap region.
